(19) United States
(12) Patent Application Publication
(10) Pub. No.: US 2026/0100927 A1
(43) Pub. Date: Apr. 9, 2026

(54) SYSTEMS AND METHODS OF MONITORING A MARSHALING STATE TRANSITION OF AN AUTOMATED VEHICLE

(71) Applicant: Ford Global Technologies, LLC, Dearborn, MI (US)

(72) Inventors: Krishna Bandi, Novi, MI (US); Mario Anthony Santillo, Canton, MI (US); Meghna Menon, Ypsilanti, MI (US); Karthikeya Singirikonda, Farmington Hills, MI (US); Kalpak Kalvit, Milpitas, CA (US)

(73) Assignee: Ford Global Technologies, LLC, Dearborn, MI (US)

(21) Appl. No.: 18/910,463

(22) Filed: Oct. 9, 2024

(51) Int. Cl. H04L 51/222; H04W 4/021; H04W 4/44

(52) U.S. Cl. CPC H04L 51/222; H04W 4/022; H04W 4/44

(57) ABSTRACT

A method includes the monitoring of an exchange of one or more messages with an infrastructure system, the performance of an analysis of the one or more messages, the generation of a virtual dynamic boundary associated with a marshaling environment, and the de-boarding of the vehicle in response to a current location of the vehicle being outside of the virtual dynamic boundary.

### FIELD

The present disclosure relates to monitoring a marshaling state transition associated with a vehicle. More specifically, the present disclosure relates to monitoring a state transition of the vehicle within a particular area of a marshaling environment.

### BACKGROUND

The statements in this section merely provide background information related to the present disclosure and may not constitute prior art.

The marshaling of one or more vehicles within an operational design domain presents challenges associated with accurate onboarding and de-boarding of the one or more vehicles with an infrastructure system. Communication variables and/or range limitations between the one or more vehicles and the infrastructure system can also create challenges. For example, an inability to facilitate successful de-boarding and/or onboarding of a vehicle can result in a violation of industry standards. Moreover, the type of communication used can limit the range by which the infrastructure can communicate with the one or more vehicles.

The present disclosure addresses these and other issues related to monitoring a marshaling state transition associated with one or more vehicles.

### SUMMARY

This section provides a general summary of the disclosure and is not a comprehensive disclosure of its full scope or all of its features.

The present disclosure provides a method comprising: monitoring, by a vehicle-marshaling algorithm of a vehicle, an exchange of one or more messages with an infrastructure system; performing an analysis of the one or more messages; generating a virtual dynamic boundary associated with a marshaling environment based on the analysis of the one or more messages; and de-boarding the vehicle in response to a current location of the vehicle being outside of the virtual dynamic boundary; further comprising: onboarding the vehicle in response to the current location of the vehicle re-entering the virtual dynamic boundary; further comprising: monitoring a state transition of the vehicle, wherein the state transition includes the de-boarding of the vehicle and the onboarding of the vehicle; wherein monitoring the exchange of the one or more messages comprises: monitoring at least one of a pattern associated with the one or more messages, a distance associated with the one or more messages, a radio-frequency-related behavior associated with the one or more messages, or a combination thereof; wherein the analysis of the one or more messages comprises: determining one or more characteristics associated with the one or more messages exchanged between the vehicle and one or more road-side units; and determining one or more characteristics associated with the one or more messages exchanged between the vehicle and one or more transmission points; wherein the one or more characteristics associated with the one or more messages exchanged between the vehicle and the one or more road-side units and the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof; and further comprising: transmitting the analysis of the one or more messages to a cloud system, wherein the transmission of the analysis includes snap-shot data associated with the current location of the vehicle; and causing a time-stamp and a virtual dynamic real-time heat map to be generated based on the transmission of the analysis.

The present disclosure provides a system comprising: an infrastructure system configured to receive one or more messages from a vehicle; and a vehicle system configured to: monitor, by a vehicle-marshaling algorithm of the vehicle, an exchange of the one or more messages with the infrastructure system, perform an analysis of the one or more messages, generate a virtual dynamic boundary associated with a marshaling environment based on the analysis of the one or more messages, and de-board the vehicle in response to a current location of the vehicle being outside of the virtual dynamic boundary; wherein the vehicle system is further configured to: onboard the vehicle in response to the current location of the vehicle re-entering the virtual dynamic boundary; wherein the vehicle system is further configured to: monitor a state transition of the vehicle, wherein the state transition includes the de-boarding of the vehicle and the onboarding of the vehicle; wherein the vehicle system configured to monitor the exchange of the one or more messages is further configured to: monitor at least one of a pattern associated with the one or more messages, a distance associated with the one or more messages, a radio-frequency-related behavior associated with the one or more messages, or a combination thereof; wherein the vehicle system configured to analyze the one or more messages is further configured to: determine one or more characteristics associated with the one or more messages exchanged between the vehicle and one or more road-side units; and determine one or more characteristics associated with the one or more messages exchanged between the vehicle and one or more transmission points; wherein the one or more characteristics associated with the one or more messages exchanged between the vehicle and the one or more road-side units and the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof; and wherein the vehicle system is further configured to: transmit the analysis of the one or more messages to a cloud system, wherein the transmission of the analysis includes snap-shot data associated with the current location of the vehicle; and cause a time-stamp and a virtual dynamic real-time heat map to be generated based on the transmission of the analysis.

The present disclosure provides one or more non-transitory computer-readable media storing processor-executable instructions that, when executed by at least one processor, cause the at least one processor to: monitor, by a vehicle-marshaling algorithm of a vehicle, an exchange of one or more messages with an infrastructure system; perform an analysis of the one or more messages; generate a virtual dynamic boundary associated with a marshaling environment based on the analysis of the one or more messages; and de-board the vehicle in response to a current location of the vehicle being outside of the virtual dynamic boundary; wherein the at least one processor is further caused to: onboard the vehicle in response to the current location of the vehicle re-entering the virtual dynamic boundary; wherein the at least one processor is further caused to: monitor a state transition of the vehicle, wherein the state transition includes the de-boarding of the vehicle and the onboarding of the vehicle; wherein the at least one processor caused to monitor the exchange of the one or more messages is further caused to: monitor at least one of a pattern associated with the one or more messages, a distance associated with the one or more messages, a radio-frequency-related behavior associated with the one or more messages, or a combination thereof; wherein the at least one processor caused to analyze the one or more messages is further caused to: determine one or more characteristics associated with the one or more messages exchanged between the vehicle and one or more road-side units; and determine one or more characteristics associated with the one or more messages exchanged between the vehicle and one or more transmission points, wherein the one or more characteristics associated with the one or more messages exchanged between the vehicle and the one or more road-side units and the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof; wherein the at least one processor is further caused to: transmit the analysis of the one or more messages to a cloud system, wherein the transmission of the analysis includes snap-shot data associated with the current location of the vehicle; and cause a time-stamp and a virtual dynamic real-time heat map to be generated based on the transmission of the analysis.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an implementation of a system for automated vehicle marshaling in accordance with one or more embodiments of the present disclosure;

FIG. 4 is a flowchart illustrating an example method for monitoring, analyzing, and informing of a de-boarding state of a vehicle in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide a means for monitoring, analyzing, and informing of a de-boarding state of a vehicle having a robust operational domain confinement that can prevent false maneuvering and/or onboarding of a vehicle outside a designated operational design domain. For example, comprehensive monitoring and/or reporting is provided, which overall reliability of the vehicle operated in an autonomous manner.

One or more embodiments also provides a robust means of wireless communication that utilizes a variety of wireless communication protocols to facilitate an exchange of messages between the vehicle and an infrastructure system. For example, this communication approach can provide a reliable and/or a redundant exchange of data. In one or more embodiments, a multi-layer localization approach is further provided that does not rely solely on infrastructure-based sensing to determine a location of the vehicle within the operational design domain. Instead, a multi-layered architecture is employed that utilizes various wireless communication protocols and/or algorithms to track a position and/or status of the vehicle, for example.

One or more embodiments provides accurate state identification that allows for the correct identification of a state of the vehicle, which facilitates reliable autonomous maneuvering of the vehicle. For example, real-time monitoring capabilities enable accurate state detection across various marshaling use cases (e.g., plant marshaling, depot marshaling, valet parking, hands-free-charging, etc.). One or more embodiments provides reliable state identification that ensures that when the vehicle leaves the operational design domain, the correct state transition is achieved, thereby preventing further autonomous control of the vehicle (e.g., by the infrastructure system) without the vehicle re-entering the operational design domain. For example, this ensures acceptable operation of the vehicle both within and outside the operational design domain.

One or more embodiments provides an enhanced reliability and redundancy when used in combination with other methods of identifying the location of the vehicle within the operational design domain. For example, the reliability of the system is enhanced and provides redundancy to support potential individual system inadequacies. One or more embodiments provides reliable operation of the vehicle within and outside the bounds of the operational design domain. For example, rogue agents can be prevented from intercepting the vehicle and/or performing unexpected behaviors through standard communication channels.

One or more embodiments provides adherence to industry standardization that is designed to operate within the operational design domain of the vehicle, thereby ensuring adherence to industry standards. For example, the adherence to industry-accepted guidelines enhances the reliability of the operations of the vehicle. One or more embodiments provides adaptability across global markets with a universal platform that can serve the automation industry across different markets and/or applications. One or more embodiments provides comprehensive reporting and/or analytics with detailed reporting and/or analytics, informing the infrastructure system and a vehicle manufacturing cloud about the vehicle entering a de-boarding state, radio-frequency related performance metrics, a position of the vehicle, sensor(s) data, a virtual dynamic real-time heat map of the wireless communications coverage, or a combination thereof. This information can enable data-driver decision-making and/or continuous system enhancements.

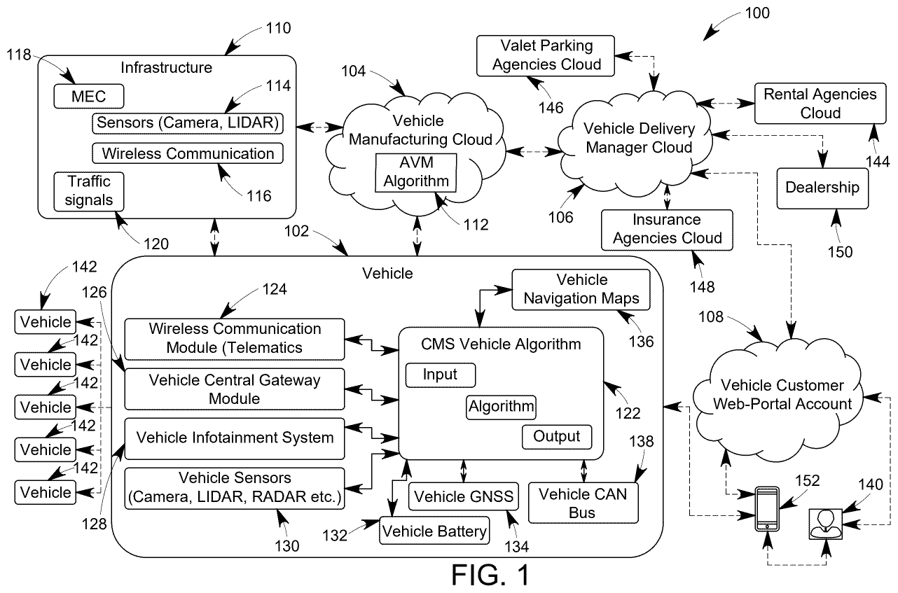

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

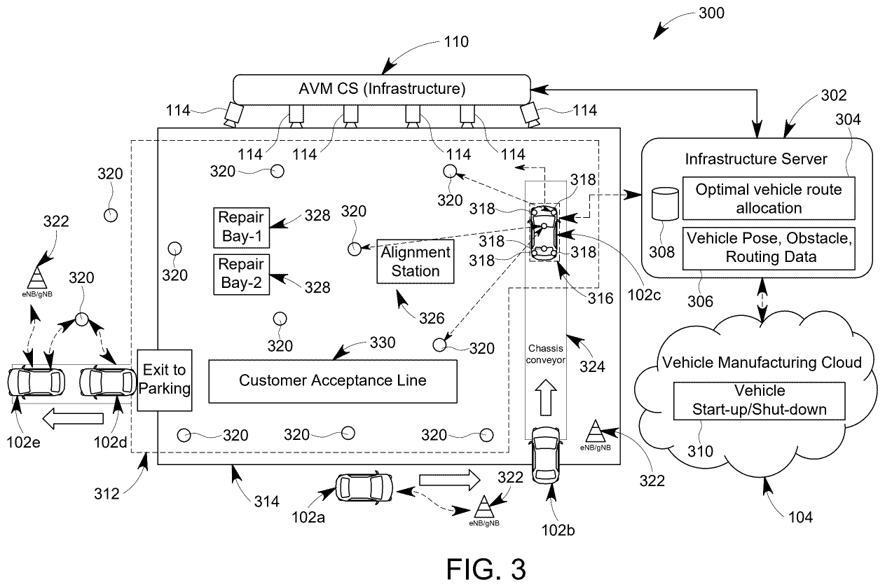

The vehicle manufacturing cloud system 104 can include an infrastructure-side AVM algorithm 112. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment (e.g., a marshaling environment 314 as shown in FIG. 3). For example, the marshaling environment 314 can represent a plant marshaling setting, an automated charging setting, a depot marshaling setting, or an underground parking setting. As an example, the plant marshaling setting can include an instance wherein just-built vehicles are moved through end-of-line testing at a vehicle assembly plant via overhead vision sensing (e.g., one or more sensors 114). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the underground parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment 314. The vehicle manufacturing cloud system 104 is further configured to control a marshaling speed of the one or more vehicles as the one or more vehicles travel through (e.g., traverse) the marshaling environment 314. For example, the vehicle manufacturing cloud system 104 utilizes the infrastructure-side AVM algorithm 112 to send instructions to the vehicle 102 and/or to process information received from the vehicle 102.

The infrastructure system 110 includes the one or more sensors 114, a wireless communication component 116, a multi-access edge computing (MEC) system 118, and one or more traffic signals 120. It is understood that the MEC system 118 is configured to support communication between the wireless communication component 116 and the vehicle 102. It is understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth® to communicate with the one or more vehicles.

The wireless communication component 116 also communicates with the one or more sensors 114 that is configured to manage and/or include, for example, one or more of cameras, lidar, radar, and/or ultrasonic devices. The one or more sensors 114 monitors the movement of the one or more vehicles as the vehicle(s) are marshaled through the marshaling environment 314. Additionally, the wireless communication component 116 is also in communication with the traffic signals 120. For example, the wireless communication component 116 may cause the traffic signals 120 to direct traffic of the one or more vehicles as the one or more vehicles are marshaled through the marshaling environment 314. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits an object (e.g., a wall or another vehicle) and is then reflected back to the vehicle 102. Based on the amount of time it takes for the sound wave to return to the vehicle 102, the vehicle 102 can determine the distance between the one or more vehicle sensors 130 and the object. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the object and is then reflected back to the vehicle 102. Based on the amount of time it takes for the electromagnetic waves to return to the vehicle 102, the vehicle 102 can determine a range, velocity, and angle of the vehicle 102 relative to the object.

The one or more vehicle sensors 130 communicate information associated with the position and/or distance at which the vehicle 102 is relative to the object to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

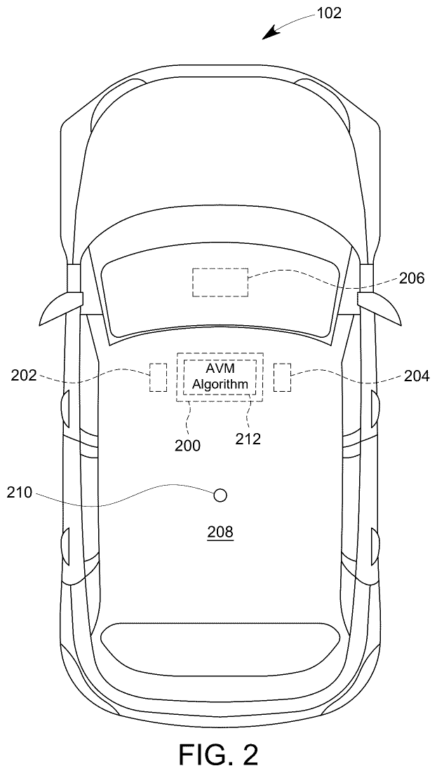

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally include the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a controller area network (CAN), or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as discussed below, various other controllers and/or sensors provide data to the vehicle controller 200 via the vehicle communication network.

In addition, the vehicle controller 200, via a vehicle-side AVM algorithm 212, is configured for communicating through a vehicle-to-infrastructure communication network, such as communicating with an infrastructure controller (not shown). The vehicle controller 200, via the vehicle-side AVM algorithm 212, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

In one or more embodiments, FIG. 3 shows a system 300 configured to provide a means for monitoring, analyzing, and/or informing of a de-boarding state (e.g., a down state, an unavailable state, a hibernation state, etc.) of the vehicle 102 (e.g., one or more vehicles 102a-102e). For example, the means for monitoring, analyzing, and/or informing of a de-boarding state of the vehicle 102 is provided by the utilization of the vehicle-side AVM algorithm 122 of the vehicle 102 in combination with the wireless exchange of one or more messages (e.g., infrastructure marshaling messages (IMMs) and vehicle marshaling messages (VMMs) with the infrastructure system 110.

As part of the system 300 depicted in FIG. 3, the infrastructure system 110 is configured to communicate with an infrastructure server 302. The infrastructure server 302 includes an optimal vehicle route allocation component 304, a vehicle pose, obstacle, and routing data component 306 and a database 308. While the infrastructure server 302 is depicted as externally disposed from the infrastructure system 110, it is understood that the infrastructure server 302 can be internally disposed within the infrastructure system 110. It is also understood that the components of the infrastructure server 302 are not limited to the optimal vehicle route allocation component 304, the vehicle pose, obstacle, and routing data component 306, and the database 308 and can include more components or less components therein.

In one or more embodiments, the vehicle-side AVM algorithm 122 is configured to monitor an exchange of states between the vehicle 102 and at least the vehicle pose, obstacle, and routing data component 306 associated with the infrastructure system 110. It is understood that the states can include an onboarding state (e.g., an identification state), a maneuvering state, or a de-boarding state. However, it is also understood that the states can include any number of marshaling states related to a communicative relationship between the vehicle 102 and the infrastructure system 110. As an example, the monitoring of the exchange of the states is accomplished utilizing a state flow identification process that includes the one or more messages.

In another one or more embodiments, the vehicle-side AVM algorithm 122 is configured to monitor the IMMs and the VMMs exchanged between the vehicle 102 and at least the optimal vehicle route allocation component 304 associated with the infrastructure system 110 to determine one or more characteristics associated with the one or more messages. For example, the one or more characteristics can include a pattern associated with the one or more messages, a distance and/or radio-frequency-related behavior associated with the one or more messages, or a combination thereof, among others. As another example, the one or more messages are exchanged wirelessly between the vehicle 102 and the infrastructure system 110 by a broadcast means, a unicast means, a multicast means, or a combination thereof. It is understood that the database 308 can be a mass storage device and/or a system memory such as a hard disk drive, a memory card, a solid-state drive, random access memory (RAM), or a combination thereof. It is also understood that the database 308 is configured to store information (e.g., data) associated with each of the optimal vehicle route allocation component 304 and/or the vehicle pose, obstacle, routing data component 306 therein.

In addition to being configured to communicate with the infrastructure system 110, the infrastructure server 302 is also configured to communicate with the vehicle manufacturing cloud system 104. As is depicted in FIG. 3, the vehicle manufacturing cloud system 104 can include a vehicle start-up/shut-down component 310. For example, the infrastructure system 110 can autonomously guide the vehicle 102 to a waypoint using a combination of the one or more sensors 114 and the vehicle sensors (e.g., the on-board sensors 204). As another example, the guidance of the vehicle 102 can include a stop movement command or a start movement command based on one or more instructions transmitted from the vehicle start-up/shut-down component 310 to the vehicle 102 (e.g., via the infrastructure system 110). However, it is understood that the one or more instructions can be transmitted directly from the vehicle start-up/shut-down component 310 to the vehicle 102.

The vehicle-side AVM algorithm 122 is also configured to perform an analysis associated with the exchange of the one or more messages and/or the exchange of states. For example, the analysis is utilized to determine a de-boarding state of the vehicle 102, which occurs when the vehicle 102 leaves a geo-fenced area 312. As another example, the analysis is utilized to determine an onboarding state of the vehicle 102, which occurs when the vehicle 102 enters (e.g., or re-enters) the geo-fenced area 312. As yet another example, the analysis can include an algorithmic function associated with any type of wireless communication means such as, but not limited to, cellular vehicle-to-everything (CV2X-PC5), Cellullar, Uu, ultra-wideband (UWB), Bluetooth® low energy (BLE), GNSS, or radio-frequency based communication. It is understood, however, that the analysis can include an algorithmic function associated with a type of wired means as well.

The vehicle-side AVM algorithm 122 is additionally configured to generate (e.g., create) the geo-fenced area 312. For example, the geo-fenced area 312 is a virtual dynamic radio-frequency-based boundary. As another example, the geo-fenced area 312 is a dynamic virtual geo-zone of an operational zone associated with the marshaling environment 314. As yet another example, the vehicle-side algorithm 122 utilizes GNSS and/or radio-frequency-based wireless communication(s) to generate the geo-fenced area 312.

The vehicle-side AVM algorithm 122 is further configured to generate a bounding box 316 (e.g., a virtual vehicle layout box). For example, the generation (e.g., creation) of the bounding box 316 can be based on a ranging location derived from the message exchange (e.g., the exchange of IMMs and VMMs) between one or more nodes 318 of the vehicle 102 and one or more anchors 320 associated with the marshaling environment 314. As an example, the one or more nodes 318 can correspond to, or represent, the on-board sensors 204.

For example, each of the one or more anchors 320 can be a transceiver configured to transmit and/or receive any communication-related messages (e.g., instructions, signals, etc.). As an example, the infrastructure system 110 and the one or more anchors 320 are communicatively coupled by a wired means. As another example, each of the one or more anchors 320 are also communicatively coupled to one another by a wired means. However, it is understood that the one or more anchors 320 may be wirelessly coupled to one another and/or the infrastructure system 110. For example, the one or more anchors 320 may be positioned throughout the marshaling environment 314 at any distance from one another. As another example, the one or more anchors 320 may be embedded within the floor of the marshaling environment 314. However, it is understood that the one or more anchors 320 may be disposed atop (e.g., not embedded within) the floor of the marshaling environment 314 as well. It is additionally understood that the one or more anchors 320 may be disposed in a variety of ways such as, but not limited to, some of the one or more anchors 320 embedded within the floor of the marshaling environment 314 and some of the one or more anchors 320 disposed atop the floor of the marshaling environment 314.

In one or more embodiments, the vehicle 102 is configured to communicate with one or more roadside units (RSU) 322 as the vehicle 102 is marshaled through the marshaling environment 314 (e.g., or proximate the marshaling environment 314). As yet another example, the one or more RSUs 322 is configured to facilitate communication between the vehicle 102 and the infrastructure system 110 and/or the vehicle manufacturing cloud system 104. As a further example, the one or more RSUs 322 is also configured to extend network connectivity, thereby supporting the communication between the vehicle 102 and the infrastructure system 110 and/or the vehicle manufacturing cloud system 104.

In one or more embodiments, the vehicle 102 can be marshaled toward the geofenced area 312 and can be caused to enter the geofenced area 312 via a chassis conveyor 324. It is understood, however, that the vehicle 102 can enter the geofenced area 312 via any means. For example, the geofenced area 312 can represent an area within an operational design domain associated with the marshaling environment 314. As the vehicle 102 enters the geofenced area 312, the vehicle-side algorithm 122 can initiate an onboarding process with the infrastructure system 110. However, it is understood that the onboarding process can be initiated before the vehicle 102 enters the geofenced area 312 or after the vehicle 102 enters the geofenced area 312 as well. The vehicle-side algorithm 122 is configured to transmit a request to at least the infrastructure system 110 for a particular message of the one or more messages (e.g., an IMM message query) upon entry of the geofenced area 312. Upon entry of the geofenced area 312 the vehicle-side algorithm 122 is also configured to transmit an alert to the infrastructure system 110 via one or more VMM messages. It is understood that the vehicle-side algorithm 122 can also transmit the request for the particular message of the one or more messages (e.g., an IMM message query) upon a re-entry of the vehicle 102 into the geofenced area 312. It is also understood that the vehicle-side algorithm 122 can also transmit the alert to the infrastructure system 110 via the one or more VMM messages upon the re-entry of the vehicle 102 into the geofenced area 312.

Once the vehicle 102 is successfully onboarded with the infrastructure system 110, the vehicle can traverse the geofenced area 312, making stop(s) at various workstations disposed therein. For example, the workstations can include, but are not limited to, an alignment station 326, one or more repair bays 328, or a customer acceptance line 330. It is understood that the one or more nodes 318 and/or the one or more RSUs 322 can aid the infrastructure system 110 and/or the vehicle marshaling cloud system 104 in marshaling the vehicle 102 through the geo-fenced area 312.

As the vehicle 102 is marshaled through the geo-fenced area 312, the vehicle-side algorithm 122 is configured to determine (e.g., calculate) and/or analyze a first set of one or more characteristics associated with the one or more messages exchanged between the vehicle 102 and the one or more RSUs 322. For example, the first set of one or more characteristics can include a congestion level, a receive signal strength indicator level, a provider service identifier, a ranging distance, or a combination thereof. As another example, the vehicle-side algorithm 122 utilizes CV2X-PC5 wireless communication(s) that support the exchange of the one or more messages between the vehicle 102 and the one or more RSUs 322 to determine the first set of one or more characteristics.

The vehicle-side algorithm 122 is also configured to determine and/or analyze a second set of one or more characteristics associated with the one or more messages exchanged between the vehicle 102 and one or more macro-identifiers (e.g., a cellular-Uu base station or any type of base station that provides coverage to an area associated with a wireless communication network) as the vehicle 102 is marshaled through the geo-fenced area 312. For example, the second set of one or more characteristics can include a change in a frequency latch, a change in physical cell identifiers received from neighboring cells, radio-frequency-related performance, latency, round-trip-time, inter-packet gap, a degradation in signal strength, a signal-to-interference-to-noise-ratio, interference, packet loss, throughput, or a combination thereof, among others. As another example, the vehicle-side algorithm 122 utilizes cellular-Uu wireless communication(s) that support the exchange of the one or more messages between the vehicle 102 and the one or more macro-identifiers to determine the second set of one or more characteristics.

Additionally, the vehicle-side algorithm 122 is further configured to determine and/or analyze a third set of one or more characteristics associated with the one or more messages exchanged between the vehicle 102 and the one or more anchors 320. For example, the third set of one or more characteristics can include information (e.g., data) associated with precise ranging distance, a received signal strength indicator, or a combination thereof. As another example, the vehicle-side algorithm 122 utilizes UWB and/or BLE wireless communication(s) that support the exchange of the one or more messages between the vehicle 102 and the one or more anchors 320 to determine the third set of one or more characteristics.

As the vehicle 102 exits the geofenced area 312, the vehicle-side algorithm 122 can initiate a de-boarding process with the infrastructure system 110. However, it is understood that the de-boarding process can be initiated before the vehicle 102 exits the geo-fenced area 312 or after the vehicle 102 exits the geofenced area 312 as well. Upon the exit of the vehicle 102 from the geofenced area 312, vehicle-side algorithm 122 also causes the vehicle 102 to transmit an alert (e.g., one or more signals) to the vehicle manufacturing cloud system 104 and/or the infrastructure system 110. For example, the alert informs the vehicle manufacturing cloud system 104 and/or the infrastructure system 110 that the vehicle 102 will be de-boarding from the infrastructure system 110.

In one or more embodiments, the vehicle-side algorithm 122 is configured to inform at least the vehicle manufacturing cloud system 104 of the radio-frequency related performance metrics (e.g., the first set of one or more characteristics, the second set of one or more characteristics, the third set of one or more characteristics, or a combination thereof). In another one or more embodiments, the vehicle-side algorithm 122 is also configured to generate a time-stamp and a virtual dynamic radio-frequency based coverage heat map associated with the marshaling environment 314. For example, the radio-frequency based coverage heat map is generated in response to a verification of a location of the vehicle 102 based on coordinates (e.g., X-, Y- and/or Z-coordinates) of the vehicle 102 matching snap-shot data associated with the location of the vehicle 102.

In one or more embodiments, the vehicle-side algorithm 122 is further configured to inform at least the infrastructure system 110 that the vehicle 102 has initiated the de-boarding process based on the analysis. The vehicle-side algorithm 122 is also configured to inform at least the infrastructure system 110 that the vehicle shall stop requesting particular messages of the one or more messages (e.g., IMM message query and/or a VMM message alert).

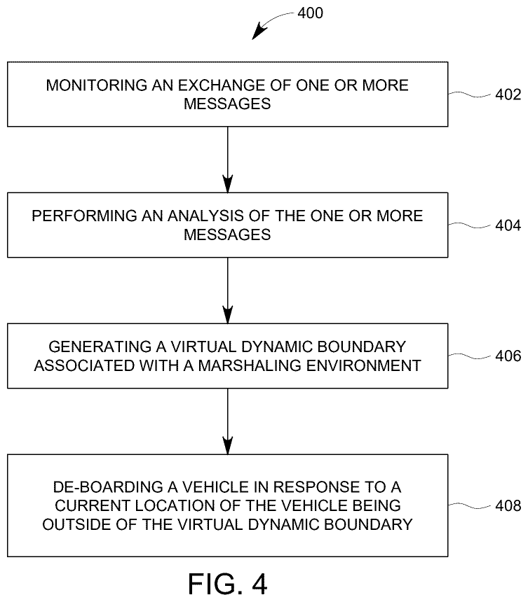

FIG. 4 is a flowchart illustrating an example method 400 for monitoring, analyzing, and informing of a de-boarding state of a vehicle (e.g., the vehicle 102). At operation 402, an exchange of one or more messages with an infrastructure system (e.g., the infrastructure system 110) is monitored. For example, the exchange of the one or more messages is monitored by a vehicle-marshaling algorithm (e.g., the vehicle-side AVM algorithm 122) of the vehicle. In one or more embodiments, the monitoring of the exchange of the one or more messages includes monitoring at least one of a pattern associated with the one or more messages, a distance associated with the one or more messages, a radio-frequency-related behavior associated with the one or more messages, or a combination thereof.

At operation 404, an analysis of the one or more messages is performed. In one or more embodiments, the analysis of the one or more messages includes a determination of one or more characteristics (e.g., the first set of one or more characteristics) associated with the one or more messages exchanged between the vehicle and one or more road-side units (e.g., the one or more RSUs 322) and/or a determination of one or more characteristics (e.g., the third set of one or more characteristics) associated with the one or more messages exchanged between the vehicle and one or more transmission points (e.g., the one or more anchors 320). For example, the one or more characteristics associated with the one or more messages exchanged between the vehicle and the one or more road-side units and/or the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof.

At operation 406, a virtual dynamic boundary (e.g., the geofenced area 312) is generated. For example, the virtual dynamic boundary is associated with a marshaling environment (e.g., the marshaling environment 314) based on the analysis of the one or more messages. At operation 408, the vehicle is de-boarded in response to a current location of the vehicle being outside of the virtual dynamic boundary.

In one or more embodiments, the vehicle is onboarded in response to the current location of the vehicle re-entering the virtual dynamic boundary. In one or more embodiments, a state transition of the vehicle is monitored. For example, the state transition includes the de-boarding of the vehicle and the onboarding of the vehicle. In one or more embodiments, the analysis of the one or more messages is transmitted to a cloud system (e.g., the vehicle manufacturing cloud system 104). For example, the transmission of the analysis includes snap-shot data associated with the current location of the vehicle. As another example, a time-stamp and/or a virtual dynamic real-time heat map is caused to be generated based on the transmission of the analysis.

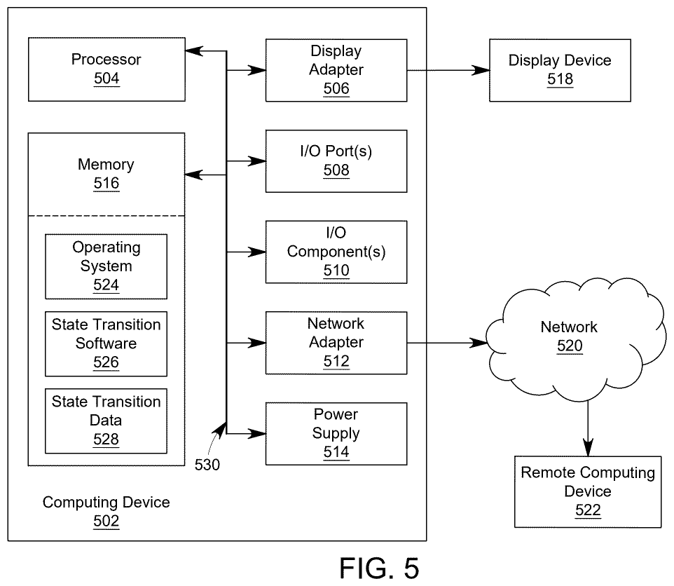

FIG. 5 illustrates an operating environment that facilitates the performance of one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, RAM, or a combination thereof. The memory 516 is configured to provide storage for instructions and data associated with the operation of the computing device 502. The memory 516 can generally include an operating system 524, state transition software 526, and state transition data 528 to perform one or more operations described in more detail herein. For example, the operating system 524 is configured to manage and/or process any of the data and/or instructions associated with the state transition software 526 and/or state transition data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provides a means for monitoring, analyzing, and informing of a de-boarding state of a vehicle at least based on a generation of a geofenced area within an operational design domain and a determination of whether the vehicle is within or outside the bounds of the geofenced area so that initiation of an onboarding state or a de-boarding state may be performed.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
monitoring, by a vehicle-marshaling algorithm of a vehicle, an exchange of one or more messages with an infrastructure system;
performing an analysis of the one or more messages;
generating a virtual dynamic boundary associated with a marshaling environment based on the analysis of the one or more messages; and
de-boarding the vehicle in response to a current location of the vehicle being outside of the virtual dynamic boundary.

2. The method of claim 1, further comprising:
onboarding the vehicle in response to the current location of the vehicle re-entering the virtual dynamic boundary.

3. The method of claim 2, further comprising:
monitoring a state transition of the vehicle, wherein the state transition includes the de-boarding of the vehicle and the onboarding of the vehicle.

4. The method of claim 1, wherein monitoring the exchange of the one or more messages comprises:
monitoring at least one of a pattern associated with the one or more messages, a distance associated with the one or more messages, a radio-frequency-related behavior associated with the one or more messages, or a combination thereof.

5. The method of claim 1, wherein the analysis of the one or more messages comprises:
determining one or more characteristics associated with the one or more messages exchanged between the vehicle and one or more road-side units; and
determining one or more characteristics associated with the one or more messages exchanged between the vehicle and one or more transmission points.

6. The method of claim 5, wherein the one or more characteristics associated with the one or more messages exchanged between the vehicle and the one or more road-side units and the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof.

7. The method of claim 1, further comprising:
transmitting the analysis of the one or more messages to a cloud system, wherein the transmission of the analysis includes snap-shot data associated with the current location of the vehicle; and
causing a time-stamp and a virtual dynamic real-time heat map to be generated based on the transmission of the analysis.

8. A system comprising:
an infrastructure system configured to receive one or more messages from a vehicle; and
a vehicle system configured to:
monitor, by a vehicle-marshaling algorithm of the vehicle, an exchange of the one or more messages with the infrastructure system,
perform an analysis of the one or more messages,
generate a virtual dynamic boundary associated with a marshaling environment based on the analysis of the one or more messages, and
de-board the vehicle in response to a current location of the vehicle being outside of the virtual dynamic boundary.

9. The system of claim 8, wherein the vehicle system is further configured to:
onboard the vehicle in response to the current location of the vehicle re-entering the virtual dynamic boundary.

10. The system of claim 9, wherein the vehicle system is further configured to:
monitor a state transition of the vehicle, wherein the state transition includes the de-boarding of the vehicle and the onboarding of the vehicle.

11. The system of claim 8, wherein the vehicle system configured to monitor the exchange of the one or more messages is further configured to:
monitor at least one of a pattern associated with the one or more messages, a distance associated with the one or more messages, a radio-frequency-related behavior associated with the one or more messages, or a combination thereof.

12. The system of claim 8, wherein the vehicle system configured to analyze the one or more messages is further configured to:
determine one or more characteristics associated with the one or more messages exchanged between the vehicle and one or more road-side units; and
determine one or more characteristics associated with the one or more messages exchanged between the vehicle and one or more transmission points.

13. The system of claim 12, wherein the one or more characteristics associated with the one or more messages exchanged between the vehicle and the one or more road-side units and the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof.

14. The system of claim 8, wherein the vehicle system is further configured to:
transmit the analysis of the one or more messages to a cloud system, wherein the transmission of the analysis includes snap-shot data associated with the current location of the vehicle; and
cause a time-stamp and a virtual dynamic real-time heat map to be generated based on the transmission of the analysis.

15. One or more non-transitory computer-readable media storing processor-executable instructions that, when executed by at least one processor, cause the at least one processor to:
monitor, by a vehicle-marshaling algorithm of a vehicle, an exchange of one or more messages with an infrastructure system;
perform an analysis of the one or more messages;
generate a virtual dynamic boundary associated with a marshaling environment based on the analysis of the one or more messages; and
de-board the vehicle in response to a current location of the vehicle being outside of the virtual dynamic boundary.

16. The one or more non-transitory computer-readable media of claim 15, wherein the at least one processor is further caused to:
onboard the vehicle in response to the current location of the vehicle re-entering the virtual dynamic boundary.

17. The one or more non-transitory computer-readable media of claim 16, wherein the at least one processor is further caused to:
monitor a state transition of the vehicle, wherein the state transition includes the de-boarding of the vehicle and the onboarding of the vehicle.

18. The one or more non-transitory computer-readable media of claim 15, wherein the at least one processor caused to monitor the exchange of the one or more messages is further caused to:
monitor at least one of a pattern associated with the one or more messages, a distance associated with the one or more messages, a radio-frequency-related behavior associated with the one or more messages, or a combination thereof.

19. The one or more non-transitory computer-readable media of claim 15, wherein the at least one processor caused to analyze the one or more messages is further caused to:
determine one or more characteristics associated with the one or more messages exchanged between the vehicle and one or more road-side units; and
determine one or more characteristics associated with the one or more messages exchanged between the vehicle and one or more transmission points,
wherein the one or more characteristics associated with the one or more messages exchanged between the vehicle and the one or more road-side units and the one or more transmission points include a congestion level, a received signal strength indicator level, a PSID, a ranging distance, a change in a frequency latch, a change in physical cell identifiers received from neighboring cells, radio-frequency-related performance, latency, RTT, IPG, a degradation in signal strength, a signal-to-interference-to-noise-ratio, interference, packet loss, throughput, or a combination thereof.

20. The one or more non-transitory computer-readable media of claim 15, wherein the at least one processor is further caused to:
transmit the analysis of the one or more messages to a cloud system, wherein the transmission of the analysis includes snap-shot data associated with the current location of the vehicle; and
cause a time-stamp and a virtual dynamic real-time heat map to be generated based on the transmission of the analysis.
